(19) United States
(12) Patent Application Publication
(10) Pub. No.: US 2001/0029562 A1
(43) Pub. Date: Oct. 11, 2001

(54) Inter-processor communication apparatus and method of mobile communication system

(75) Inventor: Byung Hyo Kim, Kunpo (KR)

Correspondence Address: FLESHNER & KIM, LLP, P.O. Box 221200, Chantilly, VA, 20153-1200, US

(73) Assignee: LG Electronics Inc.

(21) Appl. No.: 09/801,639

(22) Filed: Mar. 9, 2001

(30) Foreign Application Priority Data
Mar. 9, 2000 (KR) 11811/2000

(51) Int. Cl. G06F 13/38

(52) U.S. Cl. 710/129; 710/110

(57) ABSTRACT

An inter-processor communication apparatus of a mobile communication system includes: a data-FIFO for storing a receiving data; a slave-logic for controlling a writing operation of the data-FIFO and counting the length of the receiving data until an end-tap signal is inputted; a length-FIFO for storing the data length counted by the slave-logic; and a CPU for continuously reading the data stored in the data-FIFO as much as the data read from the length-FIFO when an interrupt signal is inputted from the slave-logic. Since the data length value is applied to the CPU to read continuously the one frame data, the load of the CPU is reduced and the data processing speed is improved. Furthermore, the performance of the inter-processor communication apparatus can be accordingly enhanced.

### BACGROUND OF THE INVENTION

1. Field of the Invention

The present invention relates to a mobile communication system, and more particularly to an inter-processor communication apparatus and method of a mobile communication system.

2. Description of the Background Art

Generally, a mobile communication system includes one master unit (referred to as ‘master’, hereinafter) and a plurality of slave units (referred to as ‘slave’, hereinafter), and each units performs an inter-process communication (IPC) to transmit and receive a data.

Master serves to arbitrate data transmission and receiving between two slaves. That is, the master assigns a corresponding transmission slave a bus use right according to a bus occupation signal inputted from the transmission slave.

The transmission slave, assigned the bus use right, transmits its own ID together with a data through a data bus (Rx bus) and transmits to the master various signals, for example, a parity signal, a tag signal for indicating starting and ending of data transmission, a read signal (RD) and a write signal (WR), through each channel of a control bus.

Then, the master informs the receiving slave that there is a data to be received and transmits the data ID and various signals received from the transmission slave to the receiving slave through the data bus (Tx bus) and the control bus. At this time, the Rx and the Tx buses are set on the basis of the master, which become Tx and Rx buses in the transmission and the receiving slaves, respectively.

Accordingly, the receiving slave compares the ID of the transmission slave received from the master with its own ID, and if the two Ids are identical to each other, the receiving slave receives the data transmitted from the transmission slave.

FIG. 1 is a schematic block diagram of an inter-processor communication apparatus in accordance with a conventional art.

As shown in the drawing, the conventional inter-processor communication apparatus includes a data-FIFO 10 for temporarily storing a data transmitted from the master, a CPU 12 for reading and processing the data stored in the data-FIFO 10, and a slave-logic 14 for controlling the data writing operation of the data-FIFO 10 and the data reading operation of the CPU 12.

The operation of the conventional inter-processor communication apparatus constructed as described above will now be explained.

The master receives the data, the tag signal and the write signal (WR) from the transmission slave and transmits them through the transmission (Tx bus) to the receiving slave.

As the receiving slave receives the data, the tag signal and the write signal (WR), the slave-logic of the receiving slave outputs a write signal (WR*) to the data-FIFO 10 and searches the tag signal to check whether an end tag indicating the end of one frame data is received. And, the data-FIFO 10 stores the data and the tag signal according to the write signal (WR*) provided from the slave-logic 14.

Thereafter, when the tag signal indicating the end of the frame data, that is, the end tag, is received, the slave-logic 14 outputs an interrupt signal to the CPU 12 so that the CPU 12 starts reading the data and the tag signal from the data-FIFO 10.

When the interrupt signal is received, the CPU 12 reads the data by 1 bit unit from the data-FIFO 10, and at the same time, continuously searches the tag signal to check whether one frame of data has been completely read.

When the end tag is detected and one frame of data is completely read, the CPU 12 checks an error of the read one frame data and processes the data. At this time, there occurs an error, the receiving slave requests re-transmission of data from the mater.

As described above, the CPU of the receiving slave reads the data by 1-byte unit from the data-FIFO 10, continuously searches the tag signal transmitted by the transmission slave and processes the read data by 1 frame unit.

However, since the CPU in the conventional art should check the tag signal to discriminate whether 1 frame data has been completely read whenever a data is read, overloading occurs in data processing, which degrades the performance of the inter-processor communication apparatus.

### SUMMARY OF THE INVENTION

Therefore, an object of the present invention is to provide an inter-processor communication apparatus and method capable of improving performance of an inter-processor communication apparatus.

Another object of the present invention is to provide an inter-processor communication apparatus and method capable of reading one frame data consecutively without searching a tag signal.

To achieve these and other advantages and in accordance with the purpose of the present invention, as embodied and broadly described herein, there is provided an inter-processor communication apparatus of a mobile communication system including: a data-FIFO for storing a receiving data; a slave-logic for controlling a writing operation of the data-FIFO and counting the length of the receiving data until an end-tap signal is inputted; a length-FIFO for storing the data length counted by the slave-logic; and a CPU for continuously reading the data stored in the data-FIFO as much as the data read from the length-FIFO when an interrupt signal is inputted from the slave-logic.

To achieve the above objects, there is also provided an inter-processor communication method including the steps of: storing a receiving data in a first region; counting the length of the receiving data stored in the first region; checking whether an end tag is inputted; storing the counted data length in a second region when the end tag is inputted; and continuously reading the data stored in the first region as much as the data length stored in the second region.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of an inter-processor communication apparatus in accordance with a conventional art; and

FIG. 2 is a schematic view of an inter-processor communication apparatus in accordance with the present invention.

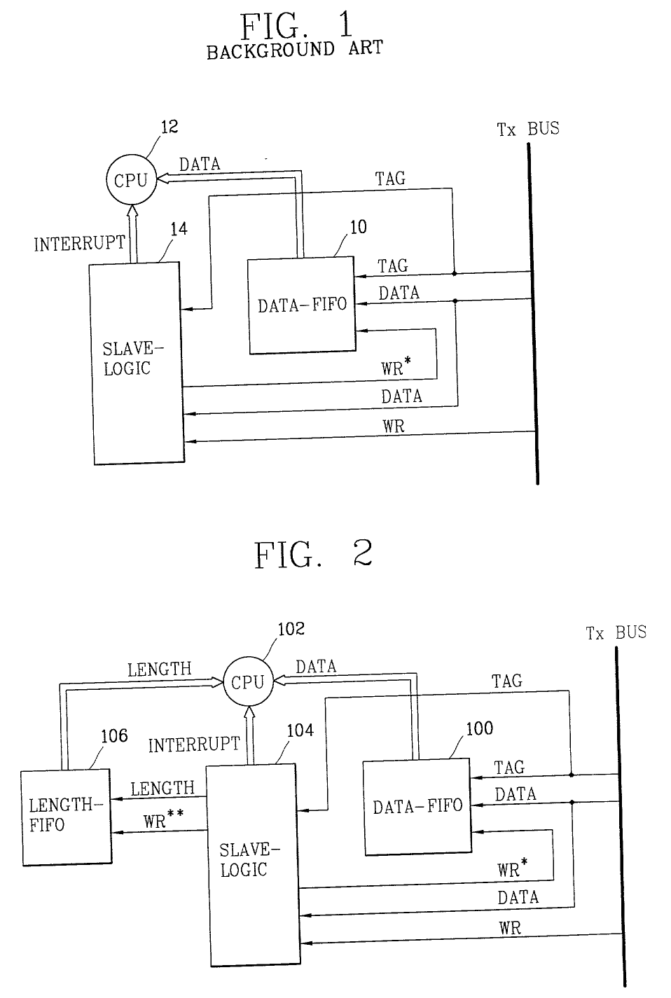

### DETAILED DESCRIPTION OF THE PREFERRED EMBODIMENTS

Reference will now be made in detail to the preferred embodiments of the present invention, examples of which are illustrated in the accompanying drawings.

FIG. 2 is a schematic view of an inter-processor communication apparatus in accordance with the present invention.

As shown in the drawing, the inter-processor communication apparatus includes a data-FIFO 100 for temporarily storing a data received from a master; a CPU 102 for continuously reading and processing the data stored in the data-FIFO 100; a slave-logic 104 for controlling a data writing operation of the data-FIFO 100 and a data reading operation of the CPU 12 and counting the length of the receiving data, and a length-FIFO 106 for temporarily storing the data length counted by the slave-logic 104.

The operation of the inter-processor communication apparatus constructed as described above will now be explained with reference to the accompanying drawing.

The master transmits a data, a tag signal and a write signal (WR) transmitted from the transmission slave through the transmission bus (Tx bus) to the receiving slave.

When the data, the tag signal and the write signal (WR) are received from the mater, the slave-logic 104 of the receiving slave first outputs a write signal (WR*) to the data-FIFO 100 to store the receiving data and the tag signal in the data-FIFO 100. And, at the same time, the slave-logic 104 counts the receiving data and increases sequentially the data length value.

Thereafter, when an end tag indicating the end of one frame data is received, the slave-logic 104 outputs an interrupt signal to the CPU 102 and outputs the counted data length together with a write signal (WR**) to the length-FIFO 106.

Then, the CPU 102 reads the data length from the length-FIFO 106 according to the interrupt signal outputted from the slave-logic 104 and continuously reads the data stored in the data-FIFO 100 as much as the read data length (one frame).

Thereafter, when the one frame data is completely read, the CPU 102 checks an error of the read data and processes it. If there is an error, the CPU 102 requests re-transmission of data from the master.

In this manner, the CPU 102 continuously reads the data corresponding to the data length (one frame) from the data-FIFO 100 and processes it, rather than searching the tag signal one by one whenever the length data is read as in the conventional art.

As so far described, the inter-processor communication apparatus and method of a mobile communication system of the present invention has the advantage that the data length value is applied to the CPU to read continuously the one frame data, so that the load of the CPU is reduced and the data processing speed is improved. Furthermore, the performance of the inter-processor communication apparatus can be accordingly enhanced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. An inter-processor communication apparatus of a mobile communication system comprising:
a data-FIFO for storing a receiving data;
a slave-logic for controlling a writing operation of the data-FIFO and counting the length of the receiving data until an end-tap signal is inputted;
a length-FIFO for storing the data length counted by the slave-logic; and
a CPU for continuously reading the data stored in the data-FIFO as much as the data read from the length-FIFO when an interrupt signal is inputted from the slave-logic.

2. The apparatus of claim 1, wherein the slave-logic counts the length of the receiving data until an end tag signal is inputted.

3. The apparatus of claim 2, wherein the read data length is one frame data length.

4. The apparatus of claim 1, wherein the slave-logic stores the counted data length in the length-FIFO when the end tag signal is inputted and outputs an interrupt signal to the CPU.

5. The apparatus of claim 1, wherein the CPU continuously reads the data stored in the data-FIFO by 1 byte unit as much as the data length stored in the length-FIFO.

6. An inter-processor communication method of a mobile communication system, comprising the steps of:
storing a receiving data in a first region; counting the length of the receiving data stored in the first region;
checking whether an end tag is received;
storing the counted data length in a second region when the end tag is received and outputting an interrupt signal to a CPU; and
continuously reading the data stored in the first region by the CPU as much as the data length stored in the second region.

7. The method of claim 6, wherein the first and the second regions are FIFO.

8. The method of claim 6, wherein the data length stored in the second region is one frame of data length.

9. The method of claim 6, wherein the CPU continuously reads the data by 1 byte unit.
